(19) United States
(12) Patent Application Publication
(10) Pub. No.: US 2020/0048755 A1
(43) Pub. Date: Feb. 13, 2020

(54) METHOD OF PROVIDING A METALLIC SURFACE WITH A PROTECTIVE CHROMIUM DIFFUSION LAYER

(71) Applicant: MTU Aero Engines AG, Munich (DE)

(72) Inventors: Heinrich WALTER, Friedberg (DE); Ludwig HILSER, Munich (DE)

(21) Appl. No.: 16/532,595

(22) Filed: Aug. 6, 2019

(30) Foreign Application Priority Data
Aug. 9, 2018 (DE) 102018213395.6

(51) Int. Cl. C23C 8/62; C23C 8/80; F01D 5/28

(52) U.S. Cl. CPC C23C 8/62; C23C 8/80; F01D 5/288; F05D 2220/32; F05D 2300/222; F05D 2300/611; F05D 2300/701; F05D 2300/132; F05D 2230/90

(57) ABSTRACT

The invention relates to a method of providing a metallic surface with a protective diffusion layer, wherein a chromium-containing slip is applied to the surface and is then subjected to a heat treatment in order to produce the protective diffusion layer. In addition to the chromium powder, the slip contains silicon powder in order to shorten the hold time required in the heat treatment.

### CROSS-REFERENCE TO RELATED APPLICATIONS

The present application claims priority under 35 U.S.C. § 119 of German Patent Application No. 102018213395.6, filed Aug. 9, 2018, the entire disclosure of which is expressly incorporated by reference herein.

### BACKGROUND OF THE INVENTION

### 1. Field of the Invention

The present invention relates to a method of coating a metallic surface, for example a surface of a component of a turbomachine, comprising a protective diffusion layer produced from a chromium-containing slip and in particular a process which makes it possible to shorten the hold time in the heat treatment of the coated component for producing a protective chromium diffusion layer on the metallic surface.

### 2. Discussion of Background Information

In the field of gas turbines, for example stationary gas turbines or aircraft engines, components such as turbine blades made of, for example, nickel-based superalloys are usually provided with a protective diffusion layer in order to protect against oxidation and corrosion at the high temperatures prevailing during operation of the gas turbines. For this purpose, a chromium-containing slip, for example, is generally applied in a plurality of layers to the component, whereupon the component which has been coated in this way is heated to high temperatures (for example from 800° C. to 1250° C.) so as to bring about diffusion of the chromium in the slip into the surface of the component and thereby improve the oxidation and corrosion resistance of the surface. The production of the protective chromium diffusion layer can be followed by alitizing (e.g. gas-phase alitizing) of the protective diffusion layer in order to assist aluminum oxide formation and by deposition of aluminum and the resulting increase in the concentration of aluminum in the coating and in this way counter oxidative attack on the component. The relatively long hold times of the component at high temperatures, which are necessary for producing the protective diffusion layer, are disadvantageous in these methods.

It would therefore be advantageous to have available a method of coating a metallic surface with a chromium-containing slip in which the hold times in the production of the protective chromium diffusion layer can be shortened.

### SUMMARY OF THE INVENTION

The present invention provides a method having the features of the independent method claim. Advantageous embodiments are subject matter of the dependent claims. A metallic surface coated in accordance with the method of the invention is likewise provided by the present invention, as is a slip suitable for the method of the invention.

In the method of the invention for providing a metallic surface (e.g. a surface of a component of a turbomachine) with a protective chromium diffusion layer, one or more layers (for example at least two layers or coats) of a chromium-containing slip are applied to the surface to be coated, with drying of a layer which has been applied preferably been carried out before application of another layer on top of the previously applied layer. The slip used contains silicon powder in addition to the chromium powder necessary for producing the protective diffusion layer. It has surprisingly been found that this accelerates the inward diffusion of chromium into the metallic surface and thus enables the necessary hold time of the component at the high temperatures required to be shortened.

The weight ratio of chromium powder to silicon powder in the slip is in most cases at least about 5:1, e.g. at least about 6:1, at least about 7:1, at least about 8:1, at least about 9:1, at least about 9.5:1 or at least about 10:1, and is generally not greater than about 100:1, e.g. not greater than about 75:1, not greater than about 50:1, not greater than about 40:1 or not greater than about 30:1.

Both the chromium powder and the silicon powder usually have a maximum particle size and/or an average particle size of less than or equal to about 20 μm, in particular less than or equal to about 10 μm, preferably less than or equal to about 5 μm.

In general, the slip is applied at room temperature (20-25° C.). However, the temperature of the surface to be coated can also be significantly higher, but preferably not higher than about 200° C. After application of the slip, the resulting layer is preferably dried before (optionally) a further layer is applied. Drying is preferably carried out at elevated temperature, for example in the range from about 50° C. to about 200° C., e.g. in the range from about 80° C. to about 150° C. Drying can here be carried out in an air atmosphere or under reduced pressure or in a protective gas atmosphere (e.g. argon atmosphere).

It is possible to apply two, three, four, five, six, seven, eight, nine, ten or more layers of slip in succession. The thickness of a not yet dried layer is often in the range from about 1 μm to about 60 μm. As a result of drying, the thickness of the layer is reduced, with the degree of reduction depending, inter alia, on the solids content of the slip used. The thickness of the finished coating (after application and drying of all layers) is usually in the range from about 40 μm to about 10 mm, in particular in the range from about 50 μm to about 5 mm, for example in the range from about 60 μm to about 2 mm.

In general, a slip suitable for the method of the invention contains at least three significant constituents, namely particulate chromium, particulate silicon and binder. The slip usually also contains water and/or one or more organic solvents. In addition, the slip can also contain one or more further constituents, for example metal halide (e.g. CrCl₃) and/or particles of inert material (e.g. Al₂O₃).

Suitable binders are all conventional binders, in particular organic polymers (resins). Nonlimiting examples of such polymers are those which are also used in commercial paints, varnishes and coatings. Specific examples include epoxy resins, silcones, alkyd resins, acrylic resins, polyurethanes, polyvinyl chloride, polyvinyl alcohol, phenolic resins, polyesters, polyamides and polyolefins.

Examples of suitable organic solvents are all those which are used in the surface coatings industry. Nonlimiting specific examples include alcohols such as methanol, ethanol, isopropanol and butanol; glycols and glycol-containing compounds such as ethylene glycol and ethylene glycol alcohol ethers; ethers, esters, amines, amides, ketones, aldehydes, aromatic compounds such as toluene and xylene; and chlorinated hydrocarbons.

For example, the slip used according to the invention can comprise water and/or at least one liquid organic compound, in particular an oil, preferably screen printing oil.

The application of the slip to the metallic surface can be carried out in any way, for example by means of techniques which are known in the surface coatings industry, e.g. spraying, painting, dipping, pouring, roller coating and spin coating.

The metallic surface to be coated can, for example, consist of a pure metal and/or an alloy. Preferred examples of alloys include those which are used for producing components of turbomachines, in particular what are known as superalloys based on nickel and/or cobalt and/or iron which contain one or more additional metals, for example Re, W, Mo, Nb, Ta, and Ti.

Nonlimiting examples of metal substrates which can be coated using the method of the invention include components of turbomachines (in particular gas turbines), e.g. blades of guide vanes and rotor blades, blade cover strips, blade platforms and parts thereof.

After all slip layers have been applied (and preferably dried) in the method of producing a diffusion layer, the coated substrate is heated either under reduced pressure and/or under a protective gas atmosphere (e.g. argon) to a temperature which makes it possible for the chromium in the layer or layers to diffuse into the coated metallic surface. The temperature required for this depends on various factors, including the composition of the metallic surface, the desired penetration depth into the surface, the composition of the slip and the thickness of the slip layer(s). In most cases, this temperature is in the range from about 800° C. to about 1250° C., in particular in the range from about 900° C. to about 1200° C. and preferably in the range from about 1000° C. to about 1150° C. The required hold times at these temperatures are generally in the range from about 1 hour to about 24 hours, in particular from about 2 hours to about 12 hours, preferably from about 3 hours to about 6 hours. The presence of silicon in the slip shortens the hold time required (accelerates the inward diffusion of chromium into the metallic surface), for example by at least about 5%, at least about 10%, at least about 15%, at least about 20% or at least about 25%, of the hold time required in the absence of silicon.

In addition, the heat treatment for producing a protective diffusion layer is preferably carried out in an atmosphere containing one or more chromium halides, in particular a chromium-based chloride, preferably CrCl₂.

The production of the protective chromium diffusion layer is preferably followed by anodization. The anodization can, for example, be carried out as gas-phase anodization in which an aluminum-containing donor material, for example aluminum powder, together with an activator or a starting material for an activator, for example a halogen compound, is exposed for a particular time to a high temperature in order to bring about an increase in the concentration of aluminum in the surface of the correspondedly treated component. At the same time, a reducing atmosphere, for example a 3/8 mixture of a protective gas or inert gas, e.g. argon, and hydrogen, can be provided in the corresponding reaction chamber.

### BRIEF DESCRIPTION OF THE DRAWINGS

The accompanying drawings show in

FIG. 1 a polished section of a metallic surface with protective diffusion layer produced by the method of the invention;

FIG. 2 a polished section of the metallic surface shown in FIG. 1 after subsequent alitizing.

### DETAILED DESCRIPTION OF EMBODIMENTS OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show details of the present invention in more detail than is necessary for the fundamental understanding of the present invention, the description in combination with the drawings making apparent to those of skill in the art how the several forms of the present invention may be embodied in practice.

Production of a Protective Chromium Diffusion Layer.

A component made of the alloy PW 1484, which contained about 5% by weight of chromium, about 2% by weight of molybdenum, about 6% of tungsten, about 3% by weight of rhenium, about 9% by weight of tantalum, about 5% by weight of aluminum, about 10% by weight of cobalt, unavoidable impurities and minor amounts of further alloy constituents plus nickel as balance, was coated with a slip containing chromium powder and silicon powder in a ratio of 9.5:1. The slip additionally contained a small amount of CrCl₃.

The slip was applied by spraying to the component to be coated. After application, the slip was dried at 50° C. under reduced pressure and subsequently at 100° C. in air for half an hour. The thickness of the slip which had been dried in this way was 150 μm. The component was then subjected in a furnace to a heat treatment at a temperature of 1080° C. in an argon atmosphere containing a small amount of CrCl₂ for 4 hours.

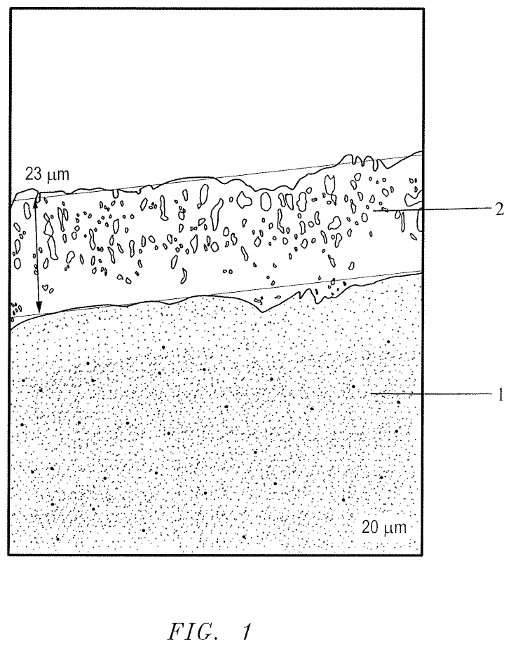

FIG. 1 shows a polished section (after molybdic acid etching) of a coated surface produced in this way (enlargement 1000:1).

As can be seen from FIG. 1, the protective diffusion layer 2 produced on the component 1 had a thickness of about 20 μm. Analysis of the surface of the component showed the concentrations indicated in the table below of the elements present therein (in % by weight) as a function of the distance from the outer surface of the protective diffusion layer 2.

| | Distance from the surface in μm | | | | | | | | | |
|---|---|---|---|---|---|---|---|---|---|---|
| | Al | Si | Cr | Fe | Co | Ni | Mo | Ta | W | Re |
| 1 | 4.9 | 4.5 | 61.5 | 1.6 | 5.5 | 18.0 | 1.6 | 0.0 | 2.5 | 0.0 |
| 3 | 11.9 | 1.9 | 63.6 | 0.8 | 2.6 | 12.6 | 1.3 | 0.0 | 3.9 | 1.4 |
| 5 | 3.3 | 3.2 | 57.0 | 1.2 | 4.5 | 19.1 | 1.9 | 2.9 | 5.2 | 1.8 |
| 7 | 3.9 | 3.2 | 53.5 | 1.5 | 5.8 | 21.0 | 1.9 | 0.0 | 5.6 | 3.6 |
| 9 | 2.3 | 3.3 | 53.6 | 1.7 | 6.2 | 22.1 | 2.0 | 0.0 | 5.7 | 3.0 |
| 11 | 0.3 | 3.7 | 49.2 | 1.5 | 5.5 | 23.0 | 2.8 | 4.6 | 6.7 | 2.7 |
| 13 | 1.0 | 4.3 | 36.6 | 1.1 | 4.8 | 32.7 | 2.4 | 9.6 | 6.0 | 1.6 |
| 15 | 2.6 | 2.0 | 27.7 | 1.7 | 6.6 | 52.0 | 0.0 | 2.8 | 2.9 | 1.7 |
| 17 | 2.5 | 1.7 | 26.5 | 1.6 | 6.8 | 51.1 | 1.0 | 3.0 | 4.3 | 1.6 |
| 19 | 3.8 | 1.7 | 18.8 | 0.9 | 6.9 | 54.1 | 1.0 | 7.5 | 3.8 | 1.4 |
| 21 | 5.5 | 1.4 | 10.3 | 0.5 | 7.2 | 56.6 | 1.1 | 10.2 | 4.9 | 2.3 |
| 23 | 6.3 | 0.0 | 7.3 | 0.0 | 8.8 | 57.8 | 1.9 | 9.6 | 6.1 | 2.3 |
| 25 | 6.5 | 0.7 | 6.1 | 0.0 | 9.5 | 58.5 | 2.0 | 9.1 | 5.6 | 2.1 |
| 27 | 6.3 | 0.0 | 5.7 | 0.0 | 9.6 | 58.0 | 2.3 | 9.2 | 7.1 | 2.0 |
| 29 | 5.9 | 0.0 | 5.6 | 0.0 | 9.7 | 58.0 | 2.4 | 9.5 | 6.7 | 2.4 |

As can be seen from the table above, both chromium and silicon had diffused into the component 1 to a distance of about 20 μm from the surface.

Alitizing of the Protective Diffusion Layer

The coated component was subsequently subjected to gas-phase alitizing in which the aluminum-containing donor material was deposited by means of the activator AlF₃ on the component. Alitizing was carried out at a temperature of about 1100° C. for 6 hours in an argon/hydrogen atmosphere.

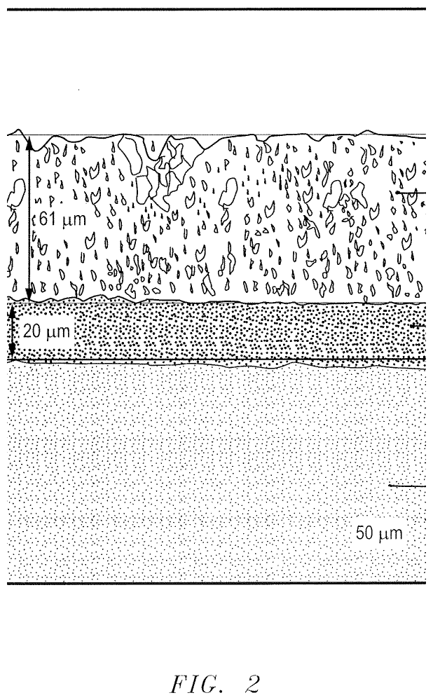

FIG. 2 shows a polished section (after molybdic acid etching) of the alitized coated surface (enlargement 500:1). As can be seen from FIG. 2, an about 60 μm thick alitizing layer 3 which consisted predominantly of aluminum was formed on the about 20 μm thick protective chromium diffusion layer 2, which is shown in FIG. 1, by means of the alitizing.

Although the present invention has been described in detail with the aid of the working examples above, it will be obvious to a person skilled in the art that the invention is not restricted to these working examples but that instead modifications involving leaving out individual features or realizing other combinations of the features are possible, as long as these modifications do not go outside the scope of protection of the accompanying claims.

### LIST OF REFERENCE NUMERALS

1 Component
2 Protective diffusion layer
3 Alitizing layer

1.-15. (canceled)

16. A method of providing a metallic substrate with a protective diffusion layer, wherein the method comprises applying a slip comprising chromium powder and silicon powder in one or more layers to the substrate, drying the slip and then subjecting the substrate to a heat treatment to form the protective diffusion layer.

17. The method of claim 16, wherein the metallic substrate is a component of a turbomachine.

18. The method of claim 16, wherein the metallic substrate comprises an alloy based on nickel and/or cobalt.

19. The method of claim 16, wherein a weight ratio of chromium powder to silicon powder in the slip ranges from 5:1 to 100:1.

20. The method of claim 19, wherein the weight ratio ranges from 7:1 to 50:1.

21. The method of claim 19, wherein the weight ratio ranges from 8:1 to 30:1.

22. The method of claim 16, wherein the chromium powder has a maximum particle size and/or an average particle size of less than or equal to 20 μm.

23. The method of claim 16, wherein the silicon powder has a maximum particle size and/or an average particle size of less than or equal to 20 μm.

24. The method of claim 22, wherein the silicon powder has a maximum particle size and/or an average particle size of less than or equal to 20 μm.

25. The method of claim 16, wherein the slip comprises water and/or at least one liquid organic compound.

26. The method of claim 25, wherein the slip comprises screen printing oil.

27. The method of claim 16, wherein the slip is applied in a thickness of from 40 μm to 10 mm.

28. The method of claim 16, wherein the slip is applied in a thickness of from 60 μm to 2 mm.

29. The method of claim 16, wherein the heat treatment for forming the diffusion layer is carried out at a temperature ranging from 800° C. to 1250° C. with a hold time of from 1 hour to 24 hours.

30. The method of claim 16, wherein the heat treatment for forming the protective diffusion layer is carried out in an atmosphere containing one or more chromium halides.

31. The method of claim 16, wherein forming the protective diffusion layer is followed by alitizing the layer.

32. The method of claim 31, wherein the alitizing of the layer is carried out as gas-phase alitizing.

33. A slip for carrying out the method of claim 16, wherein the slip comprises chromium powder and silicon powder in a weight ratio of from 5:1 to 100:1.

34. The slip of claim 33, wherein the slip comprises the chromium powder and/or the silicon powder in a maximum particle size and/or an average particle size of less than or equal to 20 μm.

35. A coated metallic substrate obtained by the method of claim 16.
